(19) United States
(12) Patent Application Publication
(10) Pub. No.: US 2005/0278735 A1
(43) Pub. Date: Dec. 15, 2005

(54) System and method for offering guest amenities

(75) Inventor: David M. Boothe, Dallas, TX (US)

Correspondence Address: RUBEN C. DELEON;WINSTEAD SECHROST & MINICK P.C., P.O. BOX 50784, DALLAS, TX, 75201, US

(73) Assignee: M-Pression Entertainment, LLC, Arlington, TX (US)

(21) Appl. No.: 11/086,554

(22) Filed: Mar. 22, 2005

Related U.S. Application Data
(60) Provisional application No. 60/575,459, filed on May 28, 2004.

(51) Int. Cl. H04N 5/445; G06F 3/00; H04N 7/10; H04N 7/025

(52) U.S. Cl. 725/34; 725/35; 725/46

(57) ABSTRACT

The present disclosure provides a method and apparatus for use in hospitality facilities to enable customers to interact with the video system used to provide directed acquisition of goods and services.

### REFERENCE TO PENDING APPLICATIONS

This application claims priority to and benefit of U.S. Provisional Application Ser. No. 60/575,459 filed on May 28, 2004, entitled: A SYSTEM AND METHOD FOR OFFERING GUEST AMENITIES, by inventor David M. Boothe [Attorney Docket No. 1030.002].

### FIELD OF THE INVENTION

The invention relates generally to video services systems and, more particularly, to a method and apparatus for use in hospitality facilities to enable customers to interact with the video system used to provide directed acquisition of goods and services.

### BACKGROUND OF THE INVENTION

Hotels offer amenities to attract guests and provide additional revenue streams. In recent years, revenue streams from these amenities have been reduced. For example, during the 1990s, local and long distance telephone calls were a major secondary revenue stream. In many hotels, these revenue streams funded the telephone systems. Since the late 1990s, the increasing popularity of cellular telephones has severely eroded this source of revenue, to the point that the phone systems have become an additional expense rather than a revenue generator.

Concurrently, hotel guests have come to expect more amenities from the hotel, often with no additional charge. For example, business travelers, often want high speed Internet access in the room, but are not willing to pay extra for it. Other guests enjoy video-on-demand, but take rates for existing systems indicate that the limit has been reached based on current pricing models. The economics of these systems make them prohibitively expensive for many hotels.

Hotel guests often request information about their local surroundings in order to make decisions on where to dine, purchase services or products they desire, or for entertainment. Traditionally, these needs have been met with the concierge or various periodical printed guides. Concierge service represents a considerable investment for the hotel, and thus is limited to higher end hotels. Due to production constraints, periodical printed guides cannot target just one hotel but must cover a larger geographic or market area. Therefore, they are not an effective marketing tool for smaller merchants geared to serving a more localized clientele. While these merchants can use yellow pages, local newspapers, hand bills and other methods to reach the market area's permanent residents, they have, so far, had no effective way to communicate with a transient, though promising, market such as the guests at a nearby hotel.

Additionally, direct mail and telephone solicitations have been losing effectiveness for several years and for several reasons. Direct marketers, particularly for more long-term items, such as credit cards, are now open to new channels to get their message across to qualified prospects. Hotel guests are a group that can be identified, demographically. Therefore, hotel in-room electronic systems are positioned to be an effective replacement for other direct marketing tools which may be losing cost-effectiveness.

Therefore, what is needed is a system that can allow local merchants to advertise at a single hotel or group of hotels.

### SUMMARY OF THE INVENTION

The present disclosure provides a method and apparatus for use in hospitality facilities to enable customers to interact with a video system used to provide directed acquisition of goods and services.

Certain aspects of the present invention seek to bring together the market needs of the hotel, the hotel guest, local advertisers and direct marketers in a mutually beneficial manner. Some aspects allow local merchants to advertise at a single hotel or a group of hotels in close proximity to the merchant's location, thus assuring that only hotel guests most likely to patronize that merchant are targeted. Direct marketers have access to an identifiable group that has not only time and focused attention, but, with the current invention, the means to assimilate and respond to an attractive marketing message. Loyalty clubs have been used for sometime to target market to the level of a single individual, and are easily adaptable to hotel populations, with the current invention. Finally, the hotel may have a flexible, multifaceted system to provide for guests' needs and wants. The financial burden of the system can be carried by the various revenue streams built in to the system: local advertising, direct marketing, targeted direct marketing (loyalty club) and fee for services, such as video-on-demand or high-speed Internet access. Thus, the hotel may be given a powerful new competitive advantage to attract new customers and keep existing ones.

The present invention provides a unique method and system for presenting information to various users, such as hotel guests. It provides for a method that accumulates information on each guest, with his or her consent, and compiles a profile for that guest. Each profile is stored in at least one database. The profile is called up when the guest next checks into a hotel that is part of the system. The hotel where the guest has checked in has at least one database containing amenities for guests. The guest profile contains the guest's preferences in terms of what he or she is most likely to need or want. The guest first encounters this system upon entering the room. The TV turns on with a barker channel running and three (more or less) amenity choices displayed. These choices and subsequent choices are presented based on the guest profile and data on local amenities using expert system techniques. Additional features are included as needed to consummate a transaction such as providing a “hot spot” or button to push that completes a telephone call to a vendor or providing video information.

Therefore, in accordance with the previous summary, objects, features and advantages of the present disclosure will become apparent to one skilled in the art from the subsequent description and the appended claims taken in conjunction with the accompanying drawings.

### BRIEF DESCRIPTION OF THE DRAWINGS

FIG. 1 is a process flow chart that illustrates one embodiment of a system incorporating several aspects of the present invention;

FIG. 2 is a block diagram that illustrates one embodiment of a system implementing the process illustrated in FIG. 1;

FIG. 3 is a process flow diagram that illustrates one embodiment of amenity selection in FIG. 1;

FIG. 4 illustrates an example of the system as illustrated in FIG. 3;

FIG. 5 illustrates one aspect of the invention for interconnecting a hotel guest to a vendor using a telephone, a prompt and TV controls;

FIG. 6 illustrates one aspect of the invention dealing with the development of guest profiles; and

FIG. 7 illustrates one aspect of the invention dealing with the interaction of a guest with the guest room portion of the invention.

### DETAILED DESCRIPTION OF THE PREFERRED EMBODIMENTS

The present invention provides a unique method and system for presenting information to various users, such as hotel guests. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

Some embodiments of the present invention are designed to give hotel guests information and entertainment services in the guestroom. In some embodiments, a hotel room guest is provided with information about merchants and service providers in the immediate vicinity of the hotel. Some embodiments can also provide supplemental revenue stream to the hotel (subject to contractual provisions). Additionally, some embodiments provide the guestroom with high-speed access to the Internet.

Certain embodiments can be deployed in either a LAN or DSL implementation, depending on size and infrastructure of the hotel. In the example embodiment discussed in this application, there is illustrated a LAN implementation.

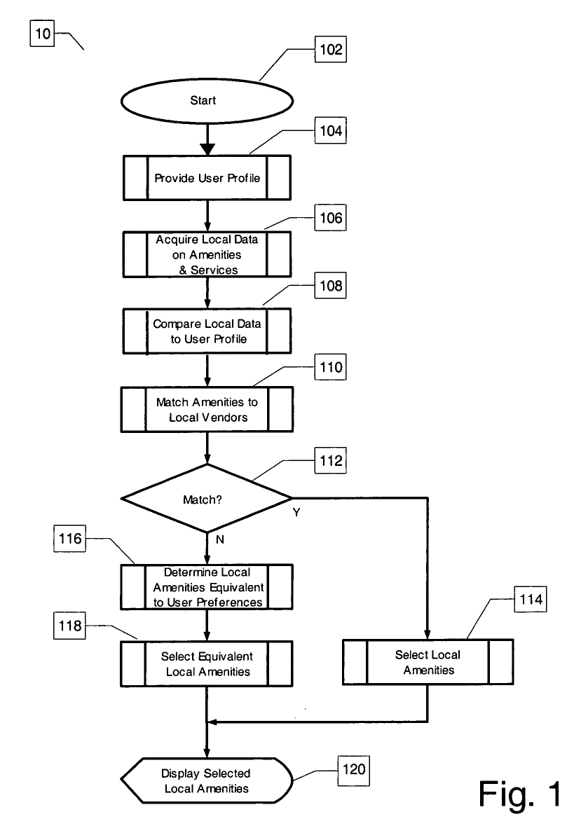

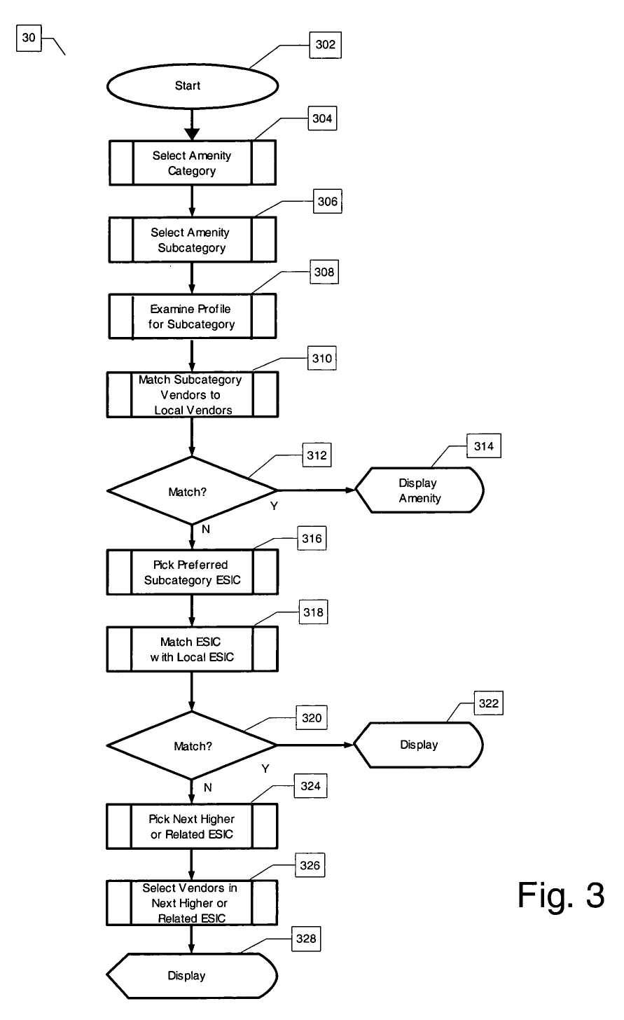

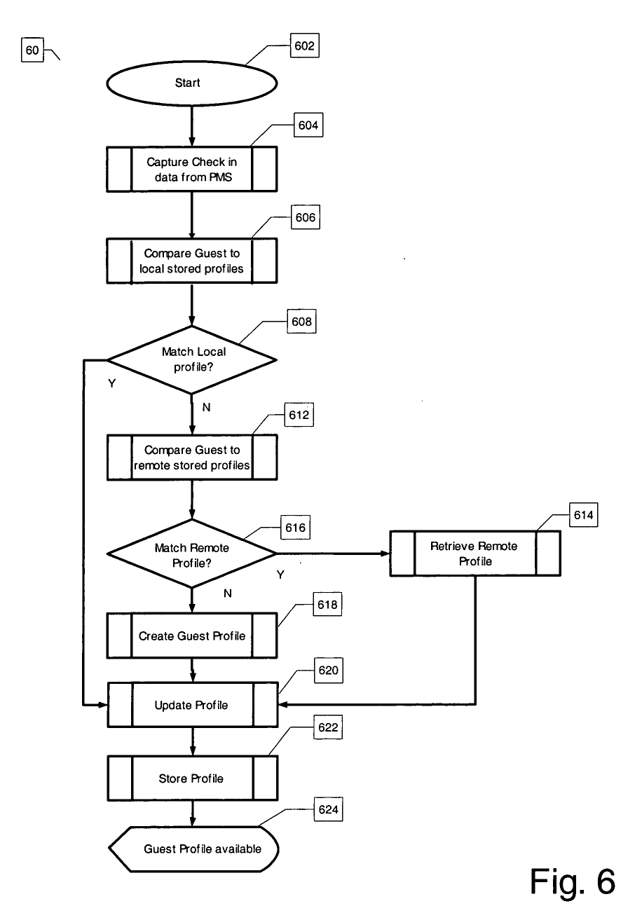

FIG. 1 describes a process whereby a guest in a hotel room is provided with a selection of services and amenities that are tailored to that guest. The process starts at step 102. In step 104, the process acquires a user profile as explained below in more detail in reference to FIG. 6. In step 106, the process may also retrieve local data on amenities and services. In step 108, the local data may then be compared to a guest profile. In steps 110 and 112, the process determines if there is a match between data in the user profile and data in the local amenities. If there is a match, then in step 114 those amenities and corresponding vendors are selected in step 114 and displayed in step 120. On the other hand, if there is no match then the process flows to step 116. In step 116 the process determines what local amenities may provide a satisfactory equivalent which may be displayed in step 120. One aspect of determining equivalents is discussed below in reference to FIG. 3.

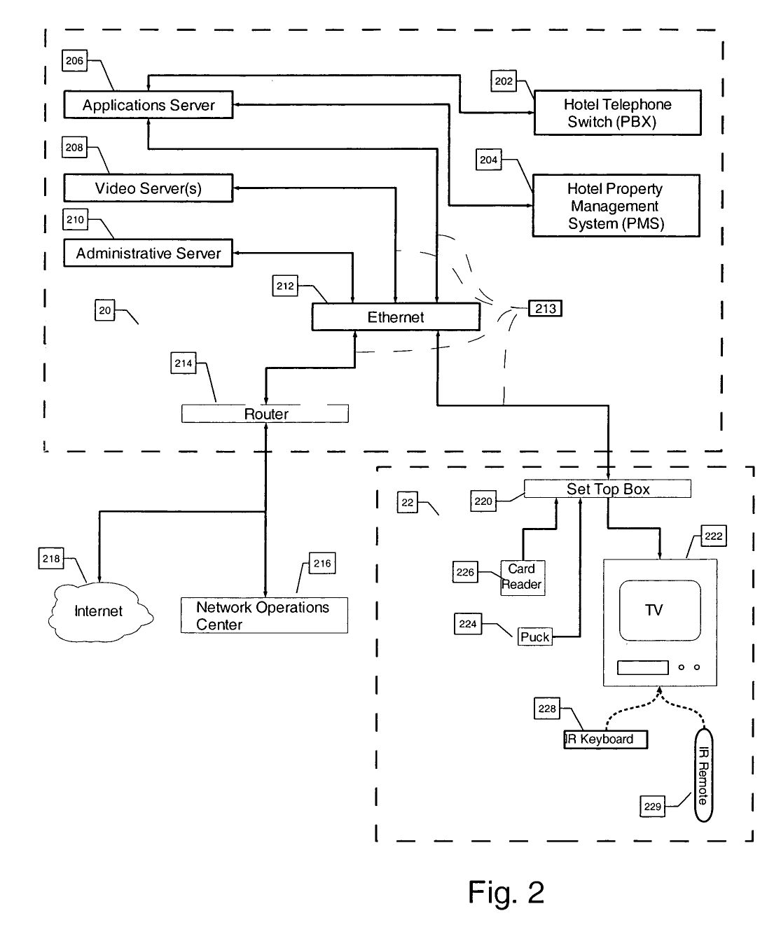

Certain embodiments may consist of components located in an equipment room or closet at the hotel and in the guestroom as illustrated in the exemplary embodiment of FIG. 2. Some embodiments may have the following exemplary equipment located in an equipment closet.

Applications Server 206. This server provides the menu system, the electronic guide, application functions, logging and tracking of pages and video files served, distribution of video material to the local video servers 208, and communications between the hotel system and Network Operations Center 216. The applications server 206 is also responsible for providing bridging services between the guest room phone and the advertiser, where applicable. It also acts as a proxy server for guest and staff Internet access.

Administrative Server 210. This server provides administrative functions and security authorizations for all set-top boxes 220 and video servers 208.

One or more video servers 208. These servers provide uni-cast or multi-cast compressed and encrypted video such as MPEG-2 to the set-top boxes 220. They are capable of serving multiple files to multiple guests simultaneously.

Router 214. The router 214 may provide access to both a Virtual Private Network and the public Internet 218 over a broad band link (e.g., a T1 line) installed at the hotel. This provides the link to a Network Operations Center 216.

One or more Ethernet switches 212. These provide interconnection between all the components of the system.

Hotel Telephone Switches (PBX) 202. Provides bridge between the hotel guest and the public switched telephone system when the guest selects a dial out to a vendor from a TV screen.

Hotel Property Management System (PMS) 204. Provides guest data to the applications server 206 for initial guest profiles and for updates to that profile for subsequent visits.

Some embodiments may have the following exemplary equipment located in the guestroom.

Set-Top Box 220. This provides browser-like capability for menus, advertising and other graphic display, control inputs, television control output, MPEG video decoding, video and audio output for the television. It has connections for the Ethernet network 213, the guest's laptop computer (Ethernet), audio/video/serial data to the television 222, and a card reader 226 via a suitable connector such as a PS2 connector.

Commercial television 222. The television 222 provides standard broadcast television viewing capability with the addition of a serial data port for two-way communication with the set-top box 220. The television's infrared receiver is used to receive commands from the remote control 229, which are then passed along to the set-top box 220 for interpretation. If the commands are for the television 222 itself, the set-top box 220 passes them back to the serial port, appropriately formatted. The serial port uses protocol proprietary to the television manufacturer.

Infrared (IR) remote control 229. This is a small control similar to a standard TV remote, but with added functions to control features of the system.

Infrared (IR) keyboard 228. This QWERTY keyboard provides alphanumeric input to the set-top box 220, when required, via the IR receiver in the television 222.

Card reader 226. This is a standard credit card reader that the guest can use to input credit card information in lieu of typing it in with the keyboard 228. It connects to the set-top box via a suitable keyboard connection such as a PS2 keyboard connection. (The keyboard is infrared and therefore does not need the PS2 connector.)

Ethernet puck 224. This is a small desktop device containing an RJ-45 jack that the guest can connect to his laptop for Internet access. The puck is connected to the second Ethernet port on the set-top box by means of an integrated crossover cable.

Each hotel system may be connected to a central Network Operations Center (NOC) 216 by a virtual private network. The NOC may manage the hotel systems, monitors system status, and distribute data and meta-data such as menu updates, video files, software upgrades, operational parameters. The NOC also retrieves logs of system usage and activity for maintenance and billing purposes. Finally, in the event of a problem, the NOC receives customer support calls from the hotel or its guests, repairs the system remotely when possible, and dispatches a field service technician when necessary.

In FIG. 3, there is described a process whereby a selection of amenities tailored to an individual hotel guest can be displayed. In one embodiment, this process may be performed in the Application Server 206 (FIG. 2). The start position 302 is determined by the profile of the hotel guest. A profile is either generated or retrieved for every guest. With each visit the system refines the guest or user profile with each interaction of the guest with the system. Each selection is tracked and logged. Each hospitality site has access to a central database containing guest profiles. In one embodiment the database is stored at a Network Operations Center (NOC) 216 (FIG. 2). This data is updated after each visit by the guest. As the profile becomes more detailed with successive visits, the expert system in the Application Server 206 (FIG. 2) will start the process with a particular amenity category. The amenity categories may be selected in step 304 by the Application Server 206 (FIG. 2). The object is to welcome the guest into his or her room by name and present a top list of amenities known to please this patron. Next the guest may select the amenity subcategory in step 306. Subcategorization may be iterative as the guest bores down through successive choices. The hotel guest may interact with the system but automation in the form of an expert system reduces the options with which the guest will be burdened.

The guest profile may be examined for preferences in the subcategory in step 308. The process now may determine local vendors that fit the subcategory in step 310. In step 312, the process determines if there is an exact match of vendors between the guest profile and the file of local vendors. If so these are displayed in step 314. If no match is found, then the process proceeds to determine a close substitute. It determines the extended Standard Industrial Classification (ESIC) (or equivalent) of the preferred subcategory in step 316. The process then attempts to match the ESIC's of local vendors in step 318. If there is a match in step 320 then the local vendors with the same ESIC are displayed in step 322. If no match in step 320 exists, then the next higher or related ESIC may be picked in step 324. In step 326, the vendors with the next higher or related ESIC are selected and then displayed in step 328. The extended Standard Industrial Classification is derived from the U.S. Department of Commerce Standard Industrial Classification (SIC) and is being replaced by the North American Industry Classification System (NAICS). Both of these systems provide a hierarchical classification system. The extended versions provide the additional granularity needed for this system. These classification systems are examples of what is required in a classification system; that is, a hierarchical system wherein lower level elements are wholly contained within elements higher in the hierarchy. This provides for vertical substitution of amenities. Picking an equivalent amenity not contained within the ESIC hierarchy, that is, picking a horizontal substitution is done using expert systems technology based in this embodiment on choices made by this guest and other guests of similar profile.

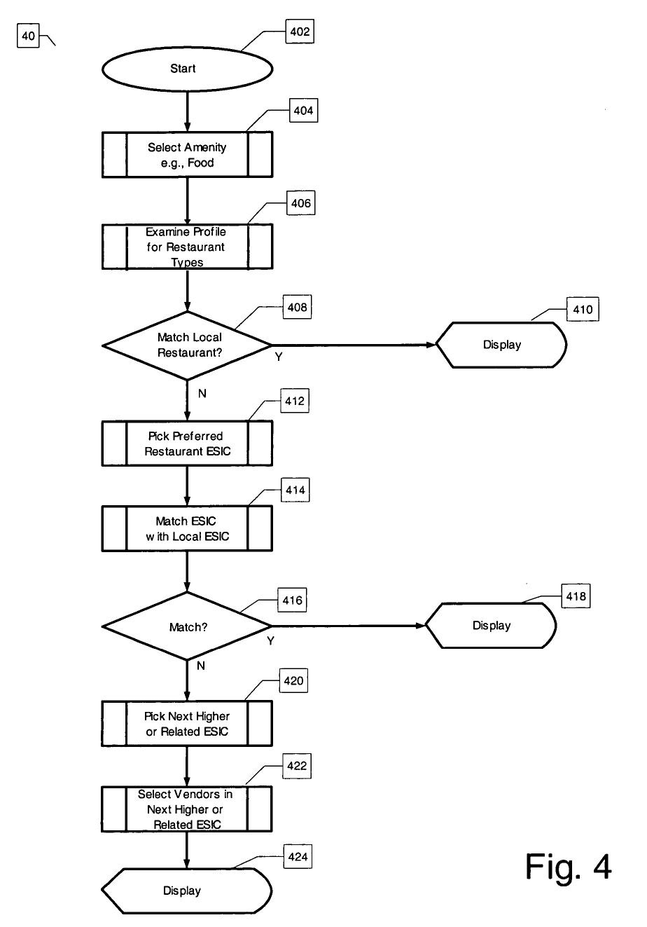

In FIG. 4, there is described a process whereby a particular amenity is selected to illustrate the process. In one embodiment, this process would be carried out in the Applications Server 206 (FIG. 2). For example, the category could be food. The particular guest is known to want to select a restaurant upon checking into the hotel so food or restaurants is among the choices on his or her TV screen. Starting at step 402 and proceeding by selecting food as the desired amenity in step 404, the process examines the guest profile in step 406 for types of restaurants preferred by the guest. For example, in restaurants say the guest prefers Mexican restaurants. If there is an exact match in step 408 with a local restaurant or restaurants, for example, a franchise restaurant, it is displayed in step 410. In there is no match in step 408, then the preferred restaurant ESIC is determined from the guest profile in step 412. In step 414 an examination of ESIC's for local restaurants is conducted. If there is a match in step 416, then it is displayed in step 418. If there is no match in step 416 then the next higher or related ESIC is selected in step 420. Vendors that have the next higher or related ESIC in step 422 are selected and displayed in step 424. The related ESIC is determined by use of expert systems technology executed in the applications server 206 (FIG. 2). In this example, the next higher ESIC above Mexican restaurant may be just “restaurant”. The expert systems technology may substitute Spanish or Salvadorian as a horizontal substitution.

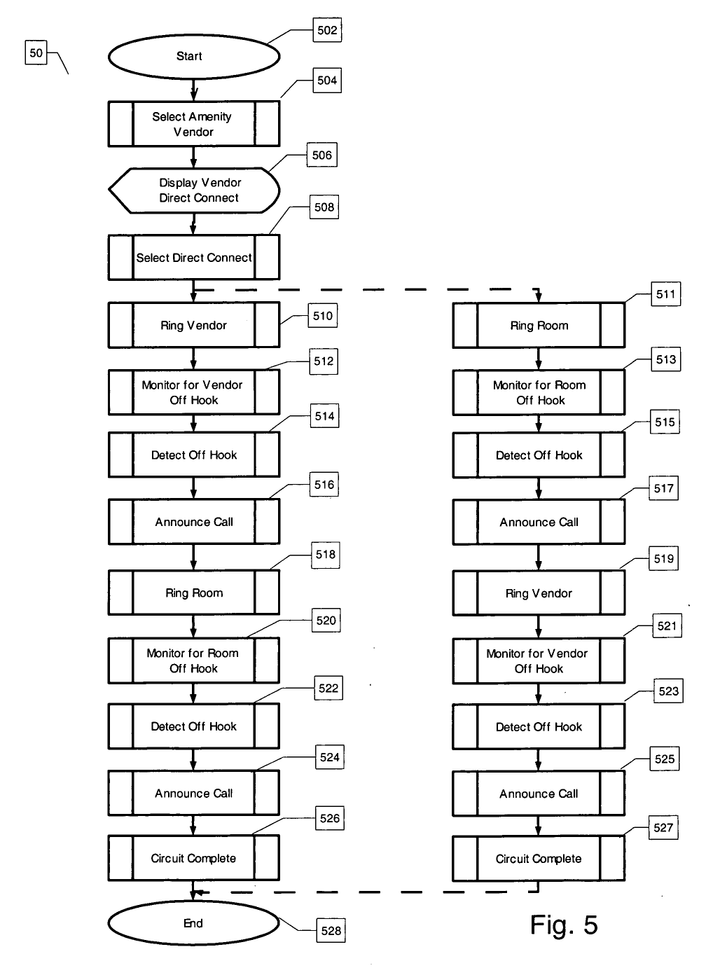

In FIG. 5, there is described a process whereby a particular amenity is selected and a telephone circuit completed to the vendor. In one embodiment, the process may be conducted by the Application Server 206 (FIG. 2). It starts at step 502 and proceeds with the guest selecting the amenity vendor in step 504. In one embodiment, this vendor's name or logo has come to be displayed on the screen as a result of the process described and illustrated in FIG. 3. The TV screen may display the direct connect capability with this vendor, step 506, by indicating a “hot spot” to click on or a button to push to make the direct telephone connection. The guest then makes the selection in step 508 for direct connection by taking the appropriate action (for example, pushing a button). The Applications Server 206 (FIG. 2) then causes the hotel PBX 202 (FIG. 2) to ring the vendor in step 510. The PBX monitors the vendor's telephone for “off hook” indication in step 512. On detecting vendor “off hook” at step 514, an appropriate announcement is made in step 516 such as “A Hotel Texas guest is attempting to contact you for a reservation”. The PBX 202 (FIG. 2) rings the guest hotel room in step 518. The PBX monitors for “off hook” condition in step 520. On detecting “off hook” condition in the guestroom in step 522, the call is announced in step 524. The communication path is complete in step 528. As indicated by the process flow in dashed lines through steps 511 to 527, the first ring can go to the hotel guest and he or she waits for the business establishment to come on the line. The call announcements provide information to each party about the intent of the call.

In FIG. 6 describes a process whereby a guest profile is acquired. In one embodiment the process is carried out in the Application Server 206. The process starts with step 602. The Property Management System (PMS) 204 (FIG. 2) provides data from guest check in step 604. The process may determine whether the guest has ever been a guest on a previous occasion. In step 606, data from the PMS may be compared with locally stored profile data to find a match. If there is a match in step 608 indicating a profile is available locally, then it is updated with any new data from PMS in step 620 and stored locally in step 622 for use. The profile is made available for use in the process in step 624 and may be used as illustrated in FIG. 1. If there is no local profile in step 608, a query may be initiated for a remotely stored profile or profiles in step 612. The remote profile may be stored typically in the Network Operations Center (NOC) 216 (FIG. 2). If a match is obtained in step 616 that profile is retrieved in step 614 and updated in step 620. If no profile exists, then a new profile is created in step 618 using the data from the PMS 204 (FIG. 2). These actions end with storing a profile in step 622. In step 624, the profile is made available for the process illustrated in FIG. 1.

In some embodiments, information and entertainment may be presented to the guest through the guest room television. Some of these services may be free to the guest, while others may require payment. In some embodiments, the guest makes selections and inputs additional required information by means of the IR remote control or the IR keyboard. Content may be displayed on the screen in the form of video, graphics, text, web content, or any combination of these formats. Video may be served locally from servers in the hotel. Other material may be served from local servers or remote servers. Locally and remotely served content may be mixed in one display as needed.

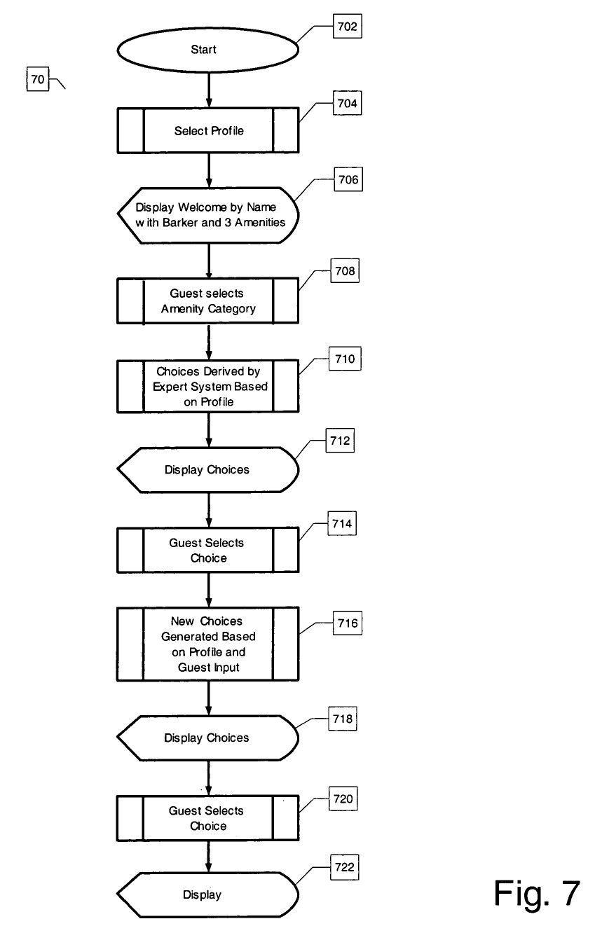

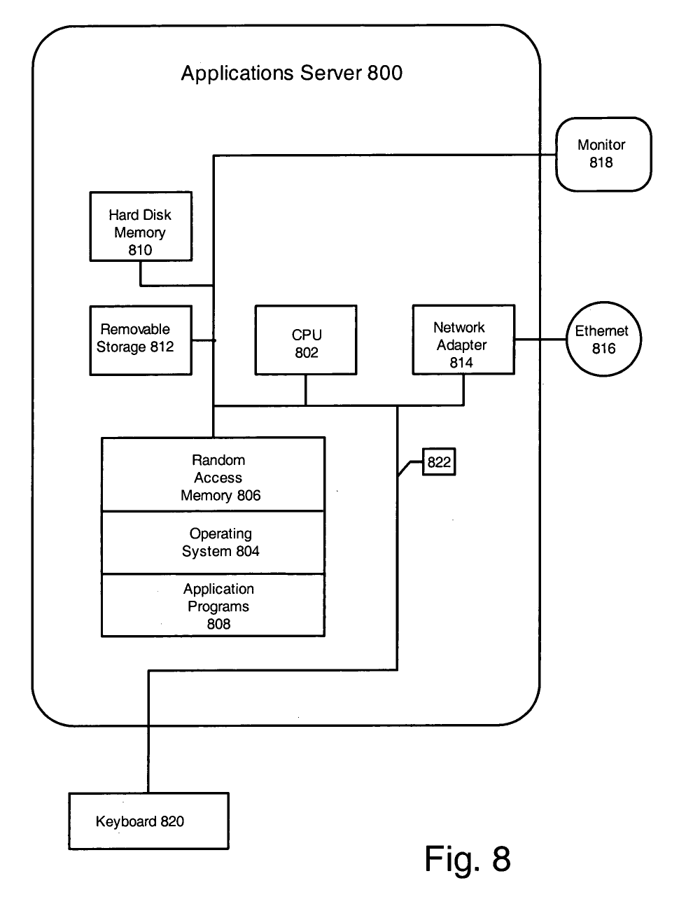

In one illustrative embodiment, a hotel desk clerk would complete guest check in and activate the room system. This would cause the TV 222 (FIG. 2) in the guest's assigned room to be remotely turned on and display the new guest's name, a barker channel, and a choice of several amenity categories. In FIG. 7, an embodiment is illustrated which includes the interaction of the guest. Starting with step 702, the process proceeds to the selection of a profile in step 704. The selection of the profile to determine amenity choices is illustrated in FIG. 6. The Applications Server 206 (FIG. 2) supplies three amenity categories to be displayed in step 706. The guest picks one in step 708, and the Applications Server 206 supplies the next tier of choices. As in the previous example, the amenity category may be food. The next set of choices could be restaurant or a meal delivery service depending on the profile. If restaurant is the choice, then Application Server 206 will generate choices in step 710 based again on the guest profile. Those choices are displayed in step 712. The process continues until a final choice is displayed. This choice is displayed in step 722 and could be further acted upon, for example by establishing a telephone connection for a reservation as illustrated in FIG. 5.

Referencing FIG. 8, an exemplary Application Server for embodiments of the invention includes a general purpose computing device in the form of a conventional computer system 800. It included a central processor unit 802, an operating system 804, random access memory 806 and a system bus 822. The system bus 822 couples various system components including the system memory in the form of hard disk memory 810 and removable storage 812 to input devices such as a keyboard 820 and network adapter 814, and output devices such as monitors and network adapter 814. The network adapter 814 makes connection by Ethernet 816 to a local area network and a wide area network as portrayed in FIG. 2. The Application Server in the preferred embodiment may be controlled from the Network Operations Center (NOC) 216 (FIG. 2) and not through local input devices. The Application Server executes application programs 808 for the implementation of the invention.

In some embodiments, the user interface may be a series of pages served by the application server. The pages may be arranged in a menu tree structure, and the guest may navigate through them with the IR remote control 229 (FIG. 2). They may consist of text and graphics with embedded control mechanisms, similar to web pages. Some of these pages may incorporate full motion video in a small window, for continuously play of video presentations, showing currently available movie selections, sponsoring advertisers, hotel information, etc. Other presentations may be full screen video with graphic overlays or text menus with hot spots. The application server may also keep logs of the guest's navigation through the menu system and tracks which pages are requested.

When payment for a product or service is required, the guest may charge the cost to his credit card by means of a series of screens and available secure e-commerce technology. Credit card information can be input into the system by means of either a credit card reader or by typing in the appropriate information using an IR keyboard 228 (FIG. 2).

Movies and other video offerings may be selected through the menu system. Payment, if required, may be made as described above. Video is in the form of encrypted digital video files such as MPEG-2 residing on one or more of the hotel's video servers 208 (FIG. 2). When a video file is requested, a series of security negotiations between the Application Server 206 (FIG. 2), the Administrative Server 210 (FIG. 2), and the set-top box 220 (FIG. 2) must be successfully completed before the set-top box 220 is given the required authorization to decode the MPEG file. The applications server logs events related to the playback of the video file, such as start, stop, pause, resume, etc.

In some embodiments, a video that must be purchased can only be played once. In one embodiment, a process that permits interruption in the showing of a video may be conducted by the Application Server 206 (FIG. 2). The guest can stop the movie before it has completed playing and exit back to the menu system. In this situation, the guest can resume watching where he or she left off, without additional charge, by selecting that movie again. In some embodiments, the system, having logged where the movie was stopped, resumes playing at the same point, or, optionally, at a point shortly before the stop point. In certain embodiments, rewind capability may be time-limited to prevent guest playing all the way through and rewinding to the beginning to watch the movie again.

In some embodiments, there is an electronic guide that provides information to the guest about products and services available in the vicinity of the hotel. Merchants may be given the opportunity to advertise on this guide for a fee. The guest may navigate through an increasingly specialized series of categories until arriving at a specific merchant's ad page. This page may be served by the Applications Server 206 (FIG. 2), which also logs the pages viewed so this information can be provided to the advertiser. The pages consist of information about the advertiser and can include:
Advertiser's name, address and telephone number
Text description of the business, its product or service offerings
Advertiser's logo or picture
The page may contain one or more additional features, use of which, by the guest, is logged by the server. Such features may include:
An automatically dialed connection between the guest's room phone and the merchant
A link to the advertiser's web site
A button to play a promotional video provided by the advertiser
Additional pages containing menus, prices, etc.

Although only a few exemplary embodiments of this invention have been described in detail above, those skilled in the art will readily appreciate that many modifications are possible in the exemplary embodiments. For example, FIG. 2 illustrates an embodiment with equipment in one possible configuration. FIG. 3 illustrates some detailed aspects of the present invention. FIG. 4 provides a specific example of the embodiment illustrated in FIG. 3. FIG. 5 through 7 are detailed illustrations of aspects of the process illustrated in FIG. 1. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for customized video presentation to a user at a hospitality location having a monitor to display video services and amenities, the method comprising the steps of:
providing a user profile;
retrieving previously stored data relating to local amenities and local services;
determining whether the previously stored data matches data in the user profile; and
if the previously stored data matches the data in the user profile, then presenting video services and amenities on the monitor.

2. The method of claim 1 wherein the monitor is a television.

3. The method of claim 1 further comprising:
generating the user profile using guest data from initial registration at a hospitality location and storing the user profile in at least one database.

4. The method of claim 1 wherein the providing the user profile further comprises:
retrieving the user profile from at least one database.

5. The method of claim 1 wherein the providing the user profile further comprises:
retrieving the user profile from at least one remote database.

6. The method of claim 1 wherein the providing the user profile further comprises:
retrieving the user profile from at least one local database.

7. The method of claim 1 further comprising:
processing the user profile against data on amenities and services using expert systems techniques.

8. A method for customized video presentation to a user at a hospitality location having a display to access video services and amenities, the method comprising the steps of:
displaying an icon or other graphic image indicating the ability to contact a vendor by interaction with the display;
selecting to contact the vendor;
contacting the vendor through an application server; and
connecting the hotel guestroom to the vendor.

9. The method of claim 8 wherein the contacting the vendor includes a short message service message.

10. The method of claim 8 wherein the contacting the vendor includes:
calling the vendor on a telephone through the application server;
listening for the telephone to go “off hook”;
playing back a voice prompt to the vendor; and
ringing the hotel guestroom to complete the connection.

11. A system to provide hotel guests with individually tailored choices of amenities comprising:
at least one application server;
at least one video server;
at least one private branch exchange (PBX);
at least one TV set top control box; and
at least one television.

12. The system of claim 12 wherein the application server is a computer executing stored programs that include:
initiating profiles for hospitality establishment guests;
updating the profiles;
retrieving the profiles from a database; and
making the profiles available to other stored programs for use as input.

13. The system of claim 13 further including matching guest profiles with amenities and services.

14. The system of claim 13 wherein the database is a local database.

15. The system of claim 13 wherein the database is a remote database.
